(19) United States
(12) Patent Application Publication
(10) Pub. No.: US 2004/0141276 A1
(43) Pub. Date: Jul. 22, 2004

(54) Electrical transient protection circuit

(76) Inventors: Robert J. Custer, Westlake, OH (US); Claude Abraham, Stow, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/693,257

(22) Filed: Oct. 24, 2003

Related U.S. Application Data
(60) Provisional application No. 60/421,189, filed on Oct. 25, 2002.

(51) Int. Cl. H02H 9/06

(52) U.S. Cl. 361/118

(57) ABSTRACT

An electrical transient protection circuit in a vehicle includes an input connector, which receives an input voltage, a means for absorbing, which is electrically connected to the input connector, and a means for blocking, which is electrically connected to the input connector. At least one of the means for absorbing and the means for blocking conditions the input voltage by suppressing a voltage transient and producing a corresponding output voltage. The voltage transient is up to i) about 8 times the input voltage through a source impedance of about 0.4Ω for about 0.5 seconds, ii) about 50 times the input voltage through a source impedance of about 20.0Ω for about 1.0 millisecond, and iii) about 50 times a negative of the input voltage through a source impedance of about 20.0Ω for about 1.0 millisecond. An output connector delivers the output voltage, which is about 110% of the input voltage, to an electrical component on the vehicle.

This application claims the benefit of U.S. Provisional Application No. 60/421,189, filed Oct. 25, 2002.

### BACKGROUND

The present invention relates to electrical systems. It finds particular application in conjunction with electrical systems used in vehicles and will be described with particular reference thereto. It will be appreciated, however, that the invention is also amenable to other applications.

Electrical transients exist in systems that use electronic control unit (“ECU”) circuits and components designed for applications in 12 volt or 24 volt direct current (“DC”) vehicular (e.g., automotive) systems. Such transients also exist in systems having ECU circuits and components designed for applications in consumer electronics using isolated alternate current (“AC”) systems. Due to cost and other design constraints (e.g., physical size and heat generated from energy absorption), protection circuits for these types of systems currently do not meet performance requirements of vehicle manufacturers, component suppliers, and/or component designers. The transient inputs are described in industry documents such as Society of Automotive Engineers (SAE) standards J1455 for load dump and inductive switching conditions for both 12 volt and 24 volt systems.

The present invention provides a new and improved apparatus and method of electrical transient protection for ECU circuits and components that meets performance requirements of 24 volt vehicle electrical systems, cost and design requirements of component suppliers, and other ECU constraints.

The present invention provides a new and improved apparatus and method which addresses the above-referenced problems.

### SUMMARY

An electrical transient protection circuit in a vehicle includes an input connector, which receives an input voltage, a means for absorbing, which is electrically connected to the input connector, and a means for blocking, which is electrically connected to the input connector. At least one of the means for absorbing and the means for blocking conditions the input voltage by suppressing a voltage transient and producing a corresponding output voltage. The voltage transient is up to i) about 8 times the input voltage through a source impedance of about 0.4Ω for about 0.5 seconds, ii) about 50 times the input voltage through a source impedance of about 20.0Ω for about 1.0 millisecond, and iii) about 50 times a negative of the input voltage through a source impedance of about 20.0Ω for about 1.0 millisecond. An output connector delivers the output voltage, which is less than or equal to about 110% of the input voltage, to an electrical component on the vehicle.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates an electrical over-voltage transient protection circuit in accordance with one embodiment of the present invention;

FIG. 2 illustrates an electrical over-voltage transient protection circuit in accordance with another embodiment of the present invention;

FIG. 3 illustrates an electrical over-voltage transient protection circuit in accordance with another embodiment of the present invention; and

FIG. 4 illustrates an electrical over-voltage transient protection circuit including a transient voltage suppressor in accordance with another embodiment of the present invention.

### DETAILED DESCRIPTION OF ILLUSTRATED EMBODIMENTS

The present invention provides high electrical transient and reverse battery protection for electronic control unit (“ECU”) circuits and components designed for application in 24 Volt Direct Current (“DC”) systems used, for example, in vehicles (e.g., automobiles or heavy vehicles such as trucks, buses). At the same time, the present invention provides a 12 Volt regulated supply to electronic (e.g., consumer electronic) components in the system. The electrical transient and reverse battery protection is provided while meeting cost and performance objectives within the product constraints.

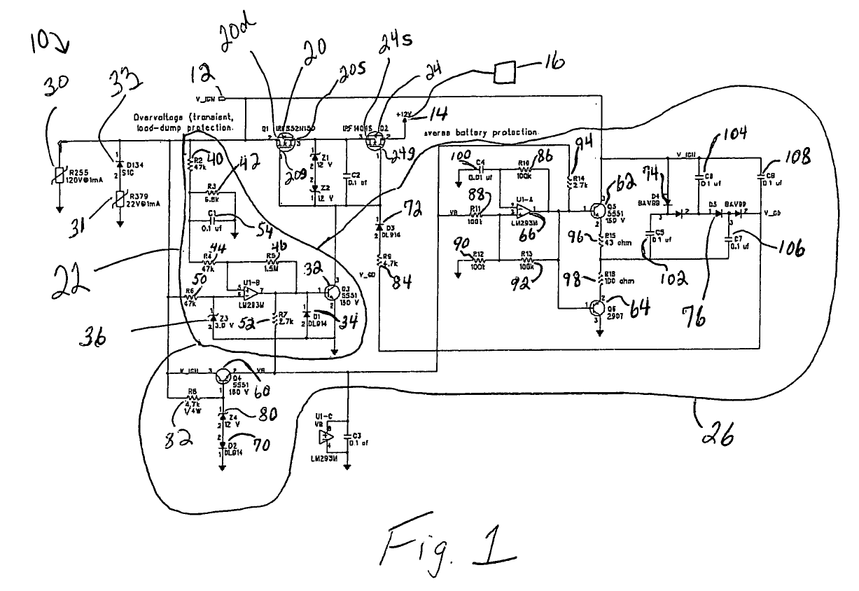

FIG. 1 illustrates an electrical over-voltage transient protection circuit 10 for suppressing electrical transients according to one embodiment of the present invention. An input connector 12 (e.g., electrical input) of the circuit 10 receives an input voltage (e.g., 12 Volts). An output connector 14 (e.g., electrical output) transmits an output voltage of the circuit 10 to electrical components 16 having a predetermined electrical rating. In one embodiment, the input connector 12 is electrically connected to an ignition circuit or directly to the battery of a vehicle (e.g., an automobile or a heavy vehicle such as a truck or bus) and the output connector 14 is connected to electrical components on the vehicle. However, other embodiments, in which the electrical over-voltage transient protection circuit is not used in conjunction with a vehicle, are also contemplated. It is to be understood that the conditioned output voltage may be delivered off board via a connector or may remain on board and used locally.

It is contemplated that the circuit 10 conditions the input voltage by suppressing over-voltage electrical transients up to: i) about 8 times the input voltage through a source impedance of about 0.4Ω for about 0.5 seconds; ii) about 50 times the input voltage through a source impedance of about 20.0Ω for about 1.0 millisecond; and iii) about 50 times a negative of the input voltage through a source impedance of about 20.0Ω for about 1.0 millisecond.

The circuit 10 includes a front end circuit with associated voltage threshold detection circuit and a FET gate voltage supply circuit for the electrical components 16. It is understood that a 24 Volt to 12 Volt converter front end circuit, know to those familiar in the art and not described here, may be added without changing the meaning of the invention described herein. More specifically, the invention provides a circuit protection means for the electrical components 16, which are rated at the predetermined electrical rating (e.g., 12 Volts), from transients produced by a 24 Volt system. The front end circuit includes an over-voltage Field Effect Transistor (“FET”) 20, an over-voltage detection and control circuit 22, a reverse battery protection FET 24, a high side FET driver gate bias circuit 26, a first absorbing means 30, and a second absorbing means 31, which is electrically connected to a diode 33. It is contemplated that the first and second absorbing means 30, 31 include a Metal Oxide Varistor (MOV) and/or a transient voltage suppressor. In this embodiment, it is contemplated that the FETs 20, 24 are n-channel switching FETs, which posses very low power consumption properties and, therefore, allow high electrical current for electronic circuits and components to operate at their maximum voltage rating.

In this embodiment, the MOV 30 and the over-voltage FET 20 operate independently of each other. Furthermore, the FET 20 is rated at about 150 Volts and the FET 24 is rated up to about 150 Volts. The over-voltage FET 20 is, for example, an n-channel FET sized for 150 Volt Load Dump requirements for isolating or blocking the electrical components 16 from transients received at the input connector 12. Therefore, the over-voltage FET 20 acts as a means for blocking the electrical transient. It is also contemplated, in other embodiments, that a bi-polar junction transistor, a silicon control rectifier (SCR), and/or a relay be used in place of the over-voltage FET 20 for blocking the electrical transient.

The reverse battery protection FET 24 is, for example, sized for 48 Volt reverse battery requirements for isolating or blocking a current path back to the input connector 12 and, furthermore, a battery source if the FET 24 is installed backwards to common convention (to prevent current conduction under reverse battery conditions (e.g., a negative input voltage)). If the FETs 20, 24 are n-channel FETs, the FET 20 includes a drain 20d connected to the input connector 12. Also, the FET 24 includes a source 24s electrically connected to a source 20s of the over-voltage FET 20 and a gate 24g electrically connected to a gate 20g of the over-voltage FET 20. Therefore, the FET 24 includes a body diode electrically connected to the FET 20. The body diode of the FET 24 is electrically oriented for blocking a negative of the input voltage. A state of the over-voltage FET 20 is controlled as a function of the input voltage, and a state of the reverse battery protection FET 24 is controlled as a function of a state of the over-voltage FET 20. In this case, the FET 24 may still be driven to an on state through the forward biased body integral diode inside the device, as is known to those in the art. However, the over-voltage FET 20 is what blocks the input. In one embodiment, the FET 24 is an n-channel 55 Volt rated FET for high current applications.

It is to be understood that if the FETs 20, 24 are p-channel FETs, the over-voltage FET includes a source connected to the input connector. Also, the reverse battery protection FET includes a drain electrically connected to a drain of the over-voltage FET and a gate electrically connected to a gate of the over-voltage FET.

The MOV 30 is sized for 600 Volt inductive switching transients through a 20Ω source impedance, which results in a voltage less than about 150 volts at the input connector 12. Such a transient requires only limited energy dissipation for short time duration transients as specified in the industry standards for an Inductive Switching Load. A MOV, which is rated to absorb only transients greater than about 125 Volts up to about 600 Volts, with a very short time duration as specified in the industry standards, will protect the over-voltage FET 20 while resulting in very small absorbed electrical currents through a MOV resistor due to a 20Ω source impedance. Therefore, the MOV 30 acts as a means for absorbing the electrical transient.

In the example discussed above, the MOV 30 is sized for less than about 150 volts, because the 600 volts from the source is divided down due to the source impedance. Consequently, the FET 24 may have a lower voltage rating than the FET 20, which requires less space.

The over-voltage detection and control circuit 22 includes a transistor 32, a diode 34, a zener diode 36, resistors 40, 42, 44, 46, 50, 52 and a capacitor 54. The over-voltage FET 20 is switched on and off by the over-voltage detection and control circuit 22. More specifically, the over-voltage detection and control circuit 22 switches the over-voltage FET 20 off when a scaled down voltage from the input connector 12 is greater than a voltage drop across the zener diode 36. When the over-voltage FET 20 is switched off, the input connector 12 does not electrically communicate with the output connector 14. Therefore, any voltage transients received at the input connector 12 are electrically blocked from the output connector 14. In other words, the over-voltage FET 20 controls an electrical connection between the input and output connectors 12, 14 as a function of the voltage transient. In this sense, the over-voltage FET 20 and the over-voltage detection and control circuit 22 act as a means for blocking the voltage transient from reaching the output connector 14.

The high side FET driver gate bias circuit 26 includes transistors 60, 62, 64, a comparator 66 and diodes 70, 72, 74, 76, 80, resistors 82, 84, 86, 88, 90, 92, 94, 96, 98, and capacitors 100, 102, 104, 106, 108. The FETs 20, 24 are controlled (turned on and off) by the high side FET driver gate bias circuit 26. The bi-polar transistor 60, which is used along with diodes 70, 80 and resistor 82 as a bias supply, must be rated to withstand 150 Volts and, in one embodiment, is a bi-polar transistor part such as 5551.

During operation, at least one of the MOV 30 and the over-voltage FET 20 condition the input voltage by suppressing any voltage transients and producing a corresponding output voltage which is less than about 200% of the input voltage. Furthermore, the output voltage is selectable to be less than or equal to a sum of the input voltage and a tolerance associated with the means for detecting 22 (e.g., down to about 110% of the input voltage). The output voltage is delivered to the output connector 14 and, furthermore, the electrical components 16.

The MOV 30 absorbs a first portion of the voltage transient and the over-voltage FET 20 blocks a second portion of the voltage transient from reaching the output connector 14. The respective portions of the voltage transient absorbed by the MOV 30 and blocked by the over-voltage FET 20 are determined as a function of a characteristic of the voltage transient. For example, a first voltage transient having certain characteristics (e.g., 600 Volts through a source impedance of about 20.0Ω for about 1.0 millisecond) is substantially absorbed by the MOV 30 because the MOV 30 and the source impedance of about 20.0Ω form a voltage divider, whereby the voltage presented to the input 12 is less than about 150 Volts (which is the rating of the over-voltage FET 20). A second voltage transient having another characteristic (e.g., 150 Volts through a source impedance of about 0.5Ω for about 0.4 seconds) is substantially blocked by the over-voltage FET 20. Furthermore, other voltage transients having characteristics between the first and second voltage transients described above are partially absorbed by the MOV 30 and partially blocked by the over-voltage FET 20.

It is to be understood that a DC to DC voltage converter such as a buck-boost or a buck as is well known in the art can be used with the protection circuit and components described in the embodiment illustrated in FIG. 1 to adapt 12 Volt system components in a 24 Volt vehicle system.

FIG. 2 illustrates a second embodiment of the present invention. For ease of understanding this embodiment of the present invention, like components are designated by like numerals with a primed (′) suffix and new components are designated by new numerals.

With reference to FIG. 2, two (2) over-voltage FETs 20′, 200 are connected in a parallel electrical arrangement with respect to each other for additional capacity to conduct the required electrical current with lower heat dissipation. It is to be understood that additional electrical current capacity may be achieved by adding additional parallel combinations of over-voltage FETs.

Furthermore, it is also contemplated to add additional reverse battery protection FETs connected in a parallel electrical arrangement in order to attain additional electrical current capacity.

It is to be understood that a DC to DC voltage converter such as a buck-boost or a buck as is well known in the art can be used with the protection circuit and components described in the embodiment illustrated in FIG. 2 to adapt 12 Volt system components in a 24 Volt vehicle system. Other circuits which perform similar DC to DC voltage conversion can be used with this invention to adapt 12 Volt system components in a 24 Volt vehicle system.

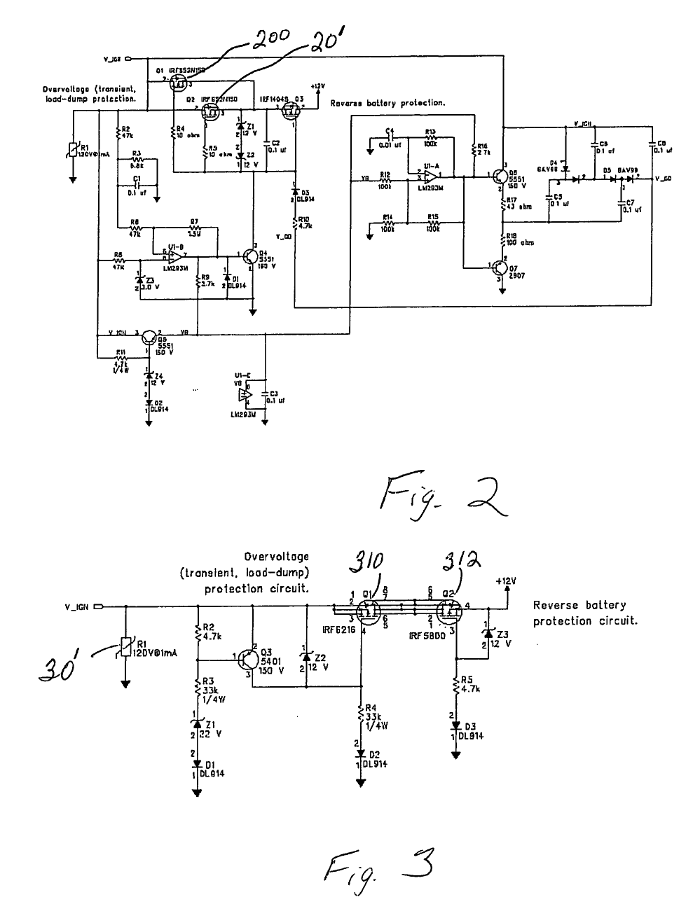

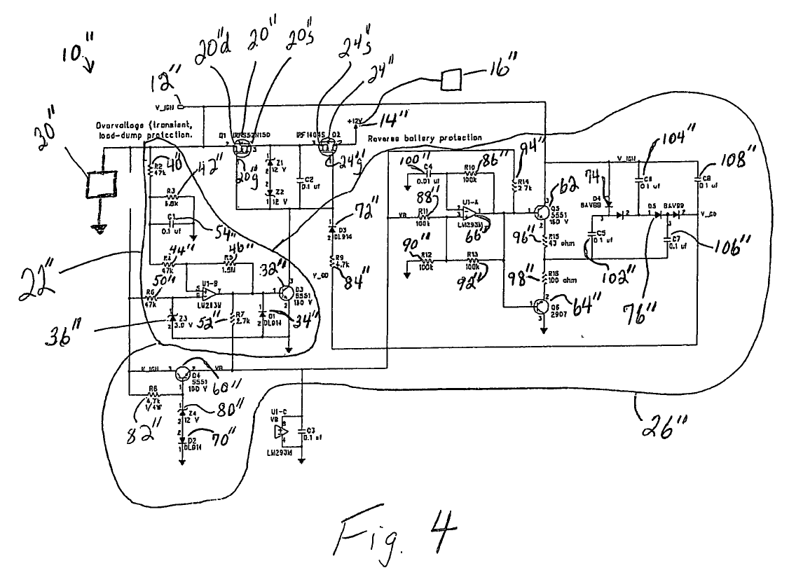

FIG. 3 illustrates a third embodiment of the present invention. In this embodiment, the electrical over-voltage transient protection circuit 10′ includes p-channel switching FETs 310, 312 along with a MOV 30′. The embodiment illustrated in FIG. 3 may be used in applications utilizing less electrical current and, therefore, does not require the use of the n-channel switching FETs, which possess very low power consumption properties and, therefore, allow high electrical current. Using p-channel switching FETs, which possess higher power consumption properties do not require the use of an associated high side driver charge pump circuit. This embodiment, therefore, has the same transient protection characteristics as the embodiment illustrated in FIG. 1. However the embodiment of FIG. 3 has the advantage of being simpler and requiring fewer parts and, therefore, has lower electrical current supply capacity.

Adding additional over-voltage FETs connected in a parallel electrical arrangement and adding additional reverse battery protection FETs connected in a parallel electrical arrangement in order to attain additional electrical current capacity constitute other contemplated embodiments of the invention since this design practice is well known to those in the art.

It is to be understood that a voltage converter such as a buck-boost or a buck as is well known in the art can be used with the protection circuit and components described in the embodiment illustrated in FIG. 3 to adapt 12 Volt system components in a 24 Volt vehicle system. Other circuits which perform similar DC to DC voltage conversion can be used with this invention to adapt 12 Volt system components in a 24 Volt vehicle system.

FIG. 4 illustrates a third embodiment of the present invention. For ease of understanding this embodiment of the present invention, like components are designated by like numerals with a double-primed (″) suffix and new components are designated by new numerals. With reference to FIG. 4, the first means for absorbing 30″ is a transient voltage suppressor.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. An electrical transient protection circuit in a vehicle, comprising:
an input connector receiving an input voltage;
means for absorbing electrically connected to the input connector;
means for blocking electrically connected to the input connector, at least one of the means for absorbing and the means for blocking conditioning the input voltage by suppressing a voltage transient and producing a corresponding output voltage, the voltage transient being up to i) about 8 times the input voltage through a source impedance of about 0.4Ω for about 0.5 seconds, ii) about 50 times the input voltage through a source impedance of about 20.0Ω for about 1.0 millisecond, and iii) about 50 times a negative of the input voltage through a source impedance of about 20.0Ω for about 1.0 millisecond; and
an output connector delivering the output voltage, which is one of less than and equal to about 10% above the input voltage, to an electrical component on the vehicle.

2. The electrical transient protection circuit as set forth in claim 1, wherein:
the means for absorbing includes a metal oxide varistor; and
the means for blocking includes a field effect transistor.

3. The electrical transient protection circuit as set forth in claim 2, wherein:
the means for absorbing absorbs a first portion of the voltage transient;
the means for blocking blocks a second portion of the voltage transient; and
the second portion may represent up to all of the voltage transient.

4. The electrical transient protection circuit as set forth in claim 2, wherein the field effect transistor is an n-channel switching field effect transistor.

5. The electrical transient protection circuit as set forth in claim 2, wherein the field effect transistor is a p-channel switching field effect transistor.

6. The electrical transient protection circuit as set forth in claim 2, wherein the means for absorbing includes a transient voltage suppressor.

7. The electrical transient protection circuit as set forth in claim 1, further including:
a field effect transistor having a body diode electrically oriented for blocking a negative of the input voltage.

8. The electrical transient protection circuit as set forth in claim 1, wherein the means for blocking controls an electrical connection between the input connector and the output connector as a function of the voltage transient.

9. The electrical transient protection circuit as set forth in claim 1, wherein the means for absorbing and the means for blocking operate independently of each other.

10. An over-voltage transient protection circuit, comprising:
an input connector receiving an input voltage;
means for absorbing an over-voltage transient up to i) about 8 times the input voltage through a source impedance of about 0.4Ω for about 0.5 seconds, ii) about 50 times the input voltage through a source impedance of about 20.0Ω for about 1.0 millisecond, and iii) about 50 times a negative of the input voltage through a source impedance of about 20.0Ω for about 1.0 millisecond;
means for blocking the over-voltage transient; and
an output connector delivering an output voltage, which is produced by at least one of the means for absorbing and the means for blocking and which is less than about 200% of the input voltage.

11. The over-voltage transient protection circuit as set forth in claim 10, wherein:
the means for blocking includes:
a first field effect transistor having a drain electrically connected to the input voltage; and
further including:
a second FET having a source electrically connected to a source of the first transistor and a gate electrically connected to a gate of the first transistor, a state of the first transistor being controlled as a function of the input voltage, and a state of the second transistor being controlled as a function of a state of the first transistor, the second FET providing protection against a negative input voltage.

12. The over-voltage transient protection circuit as set forth in claim 11, wherein the first FET is rated at about 150 volts and the second FET is rated up to about 150 volts.

13. The over-voltage transient protection circuit as set forth in claim 10, wherein:
the means for absorbing includes a metal oxide varistor; and
the means for blocking includes an n-channel field effect transistor.

14. The over-voltage transient protection circuit as set forth in claim 13, wherein the metal oxide varistor is rated up to about 150 volts.

15. The over-voltage transient protection circuit as set forth in claim 13, wherein:
the metal oxide varistor absorbs a first portion of the voltage transient;
the n-channel field effect transistor blocks a second portion of the voltage transient; and
the second portion may represent up to all of the voltage transient.

16. An electrical transient protection circuit, comprising:
an electrical input receiving an input voltage;
means for absorbing electrically connected to the electrical input;
means for blocking electrically connected to the electrical input, at least one of the means for absorbing and the means for blocking conditioning the input voltage for suppressing a voltage transient and producing a selectable output voltage one of less than and equal to a sum of the input voltage and a tolerance associated with a means for detecting the voltage transient, the voltage transient being up to i) about 8 times the input voltage through a source impedance of about 0.4Ω for about 0.5 seconds, ii) about 50 times the input voltage through a source impedance of about 20.0Ω for about 1.0 millisecond, and iii) about 50 times a negative of the input voltage through a source impedance of about 20.0Ω for about 1.0 millisecond; and
an electrical output for delivering the output voltage.

17. The electrical transient protection circuit as set forth in claim 16, wherein the means for absorbing and means for blocking operate independently of each other.

18. The electrical transient protection circuit as set forth in claim 16, wherein:
the means for absorbing includes a metal oxide varistor rated up to about 150 volts; and
the means for blocking includes a first field effect transistor rated at about 150 volts.

19. The electrical transient protection circuit as set forth in claim 18, wherein the means for blocking includes:
a second field effect transistor operates independently of the first field effect transistor.

20. The electrical transient protection circuit as set forth in claim 16, wherein:
the means for absorbing absorbs a first portion of the voltage transient; and
the means for blocking blocks a second portion of the voltage transient, the second portion being up to 100% of the voltage transient.

21. An electrical transient protection circuit, comprising:
an input receiving an input voltage;
electronic components, electrically connected to the input and having electrical ratings less than about 150 volts, for suppressing a voltage transient and producing a corresponding output voltage less than about 200% of the input voltage, the voltage transient being up to i) about 8 times the input voltage through a source impedance of about 0.4Ω for about 0.5 seconds, ii) about 50 times the input voltage through a source impedance of about 20.0Ω for about 1.0 millisecond, and iii) about 50 times a negative of the input voltage through a source impedance of about 20.0Ω for about 1.0 millisecond; and
an output for transmitting the output voltage.

22. The electrical transient protection circuit as set forth in claim 21, wherein the electronic components include a metal oxide varistor for absorbing the voltage transient.

23. The electrical transient protection circuit as set forth in claim 21, wherein the electronic components include a transient voltage suppressor for absorbing the voltage transient.

24. The electrical transient protection circuit as set forth in claim 23, wherein the electronic components include a field effect transistor for blocking the voltage transient.

25. A method for suppressing electrical transients, comprising:
receiving an input voltage via an input connector;
blocking a first portion of a voltage transient at the input connector, the voltage transient being up to i) about 8 times the input voltage through a source impedance of about 0.4Ω for about 0.5 seconds, ii) about 50 times the input voltage through a source impedance of about 20.0Ω for about 1.0 millisecond, and iii) about 50 times a negative of the input voltage through a source impedance of about 20.0Ω for about 1.0 millisecond;
if substantially all of the voltage transient is not blocked, absorbing a second portion of the voltage transient at the input connector;
producing an output voltage, which is less than or equal to about 200% of the input voltage, as a function of the input voltage, the first portion, and the second portion; and
delivering the output voltage to an output connector.

26. The method for suppressing electrical transients as set forth in claim 25, wherein:
the absorbing includes:
absorbing the second portion of the voltage transient having about 600 Volts through a source impedance of about 20.0Ω for about 1.0 millisecond; and
the blocking includes:
blocking the first portion of the voltage transient having about 150 Volts through a source impedance of about 0.5Ω for about 0.4 seconds.

27. The method for suppressing electrical transients as set forth in claim 25, wherein the blocking includes:
controlling an electrical connection between the input connector and the output connector as a function of the voltage transient.

28. The method for suppressing electrical transients as set forth in claim 25, wherein the blocking includes:
setting a field effect transistor to an open state.

29. The method for suppressing electrical transients as set forth in claim 25, further including:
selectively controlling the output voltage, as a function of tolerances associated with components in a transient detection circuit, to 110% of the input voltage.
